(19) United States
(12) Patent Application Publication
(10) Pub. No.: US 2013/0020969 A1
(43) Pub. Date: Jan. 24, 2013

(54) CONTROLLER FOR A MOVABLE CLOSURE

(71) Applicant: Jack LEIVENZON, Broadbeach Waters (AU)

(72) Inventor: Jack LEIVENZON, Broadbeach Waters (AU)

(21) Appl. No.: 13/599,660

(22) Filed: Aug. 30, 2012

(30) Foreign Application Priority Data
Jul. 10, 2011 (AU) 2001904143

(51) Int. Cl. G05D 3/12

(52) U.S. Cl. 318/16

(57) ABSTRACT

A method and control system for setting travel limit positions of a movable closure, such as a roller or sectional-panel door. The closure is movable between open and closed positions by a drive unit and associated electronic controller in response to command signals received from a remote transmitter. During an installation phase, the closure is moved in a first travel direction towards a desired first limit position in response to a user pressing and holding a command push button on the remote transmitter. The closure is then stopped when the user releases the command push button. If no command push button is pressed for a predetermined time period (e.g. 5 seconds), data representative of the closure's stopped position is stored in a memory. This data thereby defines the first travel limit position. A similar procedure may be used to store data representative of a second limit position.

### FIELD OF THE INVENTION

The present invention relates generally to a controller for a movable closure, and in particular relates to a method and system for setting travel limit positions of a movable closure.

The invention is applicable to any type of movable closure and will be described with reference to a typical garage roller door. However, the invention is equally applicable to any other type of movable closure, such as another type of door, including single or multi-panel sectional doors, as well as gates, window shutters or roller shutters. It should therefore be understood that the described method for setting travel limit positions is applicable to any type of movable closure.

### BACKGROUND TO THE INVENTION

Remotely controlled garage door openers have been in existence for many years. A typical example is shown in FIG. 1 of the accompanying drawings wherein movement of a roller door 10 is controlled by a door opener 12. The door opener 12 includes a drive unit 14 having an electric motor (not shown) for driving a door curtain 16 of the roller door 10 between open and closed positions. The door opener 12 also includes an electronic controller 18 for controlling the drive unit 14 in response to command signals received from a remote transmitter.

The position of the door curtain 16 during its vertical travel is monitored by a position encoder which is coupled to the drive unit 14. The use of a position encoder is well known in the art and avoids the need for separate sensing devices to determine the position of the door, for example to govern the travel limit positions of the door curtain 16.

In the past, the set-up of a roller door, including the setting of the open and closed travel limit positions, required an installer to access a control panel within the electronic controller. This would typically mean that the installer would have to use a ladder to access the control panel. In doing so, he would not then be able to properly see the actual position of the door curtain, especially when trying to set the closed limit position. Two people would therefore be required, one to access the control panel and the second to visually inspect the position of the door, otherwise the installer would need to repeatedly ascend and descend the ladder.

To address this shortcoming, a number of control systems have been developed which allow the installer to use the remote control transmitter to set the open and closed travel limit positions. One such example is described in European Patent Publication EP0940736 entitled ‘Electronic control system with radio remote control setting of limit stops for motors for the operation of winding devices, such as roller shades, roller shutters, rolling gates and similar’. Another example is described in Australian Patent No. AU2003204985 entitled ‘Controller system and method for controlling the operation of a movable closure’. The entire contents of EP0940736 and AU2003204985 are incorporated herein by cross reference.

Although the control systems described in these European and Australian patent publications do at least partially address the above described problem in setting the travel limit positions, they still require the installer to undergo complicated procedures involving pushing multiple push buttons on the remote control transmitter, multiple times and within defined time limits.

It would accordingly be desirable to provide a simpler and more automated method for setting the travel limit positions of a movable closure.

Any discussion of documents, devices, acts or knowledge in this specification is included to explain the context of the invention. It should not be taken as an admission that any of the material formed part of the prior art base or the common general knowledge in the relevant art in Australia or any other country on or before the priority date of the claims herein.

### SUMMARY OF THE INVENTION

With the foregoing in mind, the present invention, in one broad aspect, provides a method for setting travel limit positions of a movable closure, the closure being movable between open and closed positions by a drive unit and associated electronic controller in response to command signals received from a remote transmitter. During an installation phase, the method includes the steps of:
moving the closure in a first travel direction towards a desired first limit position in response to a user pressing and holding a first command push button on the remote transmitter;
stopping movement of the closure when the user releases the first command push button; and
if no command push button is pressed for a first predetermined time period, storing data representative of the closure's stopped position, this data thereby defining the first travel limit position.

According to this method, the first travel limit position is automatically set when the predetermined time period has elapsed. Data representative of the closure's stopped position is stored in the electronic controller. This means that an installer does not need to push any additional buttons or any combination of buttons in order to set the travel limit position. Less key strokes are required and the process becomes more automated, simpler, and more user friendly than the methods described in the abovementioned prior patent publications.

In one embodiment, the first travel limit position is the open limit position for the movable closure. If the movable closure is a typical roller door which opens vertically, the open travel limit position would be the upper limit. In this embodiment, the first travel direction would accordingly be vertically upward.

In an alternative embodiment, the first travel limit position is the closed limit. In the case of the roller door example, the closed limit would be the lower limit of travel of the door. In this embodiment, the first travel direction would be downward.

Once a first travel limit position is defined, the method may include further the steps of:
moving the closure in a second, opposite, travel direction towards a desired second limit position in response to a user pressing and holding a second command push button on the remote transmitter;
stopping movement of the closure when the user releases the second command push button; and
if no command push button is pressed for a second predetermined time period, storing data representative of the closure's stopped position, this data thereby defining the second travel limit position.

If the first travel limit position was the open limit for a roller door, the second travel limit position would be the closed limit. Conversely, if the first travel limit position was the closed limit, the second travel limit position would be the open limit.

Because an installer may not move the closure to exactly the desired first limit position on his first attempt, and may instead under or over shoot the desired position, the method of the invention preferably includes the following additional steps:
if the first command push button is pressed again within the first predetermined time period after being released, moving the closure in the first direction and stopping such movement when the first command push button is released; and if the second command push button is pressed within the first predetermined time period after the first command push button is released, moving the closure in the second direction and stopping such movement when the second command push button is released.

Similarly, while setting the second limit position, the method preferably includes the following additional steps:
if the second command push button is pressed again within the second predetermined time period after being released, moving the closure in the second direction and stopping such movement when the second command push button is released; and
if the first command push button is pressed within the second predetermined time period after the second command push button is released, moving the closure in the first direction and stopping such movement when the first command push button is released.

In this way, the installer is able to adjust the exact position of the closure to the desired limit positions. Once he is happy with each position, he merely needs to wait for the predetermined time period to elapse, upon which the data representative of the closure's final position is stored as the applicable travel limit position.

In one embodiment, the electronic controller provides a visible and/or audible signal to the installer when each of the predetermined time periods has elapsed. The visible signal may be the flashing of a light, such as a typical courtesy light which is often incorporated into automated door openers, or a beep or similar sound produced by the controller. Once the installer hears or sees the signal after setting the first limit position, he can then go on to set the second limit position.

In one embodiment, after the second limit position is set, the controller automatically switches to an OPERATE mode. The closure is then movable between the first and second limit positions.

Alternatively, where there is more than one movable closure involved, such as a dual gate arrangement having two swinging gate leaves which move between their respective open and closed positions, the controller may be configured to set the open and closed limit positions for each gate in turn. For example, the open and closed limit positions for one of the gates is set, then followed by the open and closed limit positions for the other gate. The controller may then automatically switch to the OPERATE mode. In that mode the two gates may open and close together.

In a preferred embodiment of the invention, the secondary movements of the closure, being those movements which occur after the closure is stopped the first time, proceed (at least initially) at a slower speed than the earlier movement of the closure prior to first being stopped. This makes it easier for the installer to “inch” the closure to the desired limit position after it is initially stopped in approximately the desired position. The slower speed may be in the range of 5% to 20% of the normal travel speed.

In an alternative embodiment, the secondary movements of the closure proceed according to a variable speed. For example, the travel speed may start very slowing and then gradually increase according to the length of time the command push button is depressed. The increase in speed may be linear, such that the closure gradually accelerates until it reaches to its normal travel speed, or it may be non-linear, such that the increase in speed is slower at the beginning and then rises more quickly over time. In one example, the increase in speed may be more exponential in nature, at least until the normal travel speed is reached.

In another embodiment, all movements of the closure, at least during the installation phase, are variable. The longer a command push button is depressed, the faster the closure will travel. Once again, the closure may accelerate linearly, such that it uniformly picks up speed until the normal speed (or design maximum speed) is reached, or it may accelerate nonlinearly. In any event, the closure starts to travel slowing and then its speed increases.

In one embodiment, the first predetermined time period (for example, when setting the open limit position) is equal to the second predetermined time period (for example, when setting the closed limit position). However, the two time periods could instead be different. Preferably, however, both time periods are in the range of 3-10 seconds and more preferably about 5 seconds.

Another aspect of the present invention provides a control system to implement the above described methods.

More specifically, in a broad aspect, the invention provides a control system for controlling the operation of a movable closure, the closure being movable between an open limit position and a closed limit position. The system includes:
a drive unit including an electric motor for driving the closure between the open and closed limit positions;
an electronic controller for controlling the drive unit and including a receiver for receiving command signals; and
a remote transmitter having a plurality of command push buttons for issuing the command signals to the electronic controller,
wherein, during an installation phase, the electronic controller is configured to: move the closure in a first travel direction towards a desired first limit position in response to a user pressing and holding a first command push button on the remote transmitter;
stop movement of the closure when the user releases the first command push button; and
if no command push button is pressed for a first predetermined time period, store data representative of the closure's stopped position, this data thereby defining the first travel limit position.

Preferably, the electronic controller is also configured to:
move the closure in a second, opposite, travel direction towards a desired second limit position in response to a user pressing and holding a second command push button on the remote transmitter;
stop movement of the closure when the user releases the second command push button; and
if no command push button is pressed for a second predetermined time period, store data representative of the closure's stopped position, this data thereby defining the second travel limit position.

Further preferred features of the invention may be as defined in the claims appended to this specification, such claims being incorporated into this disclosure by cross reference.

To assist the further understanding of the invention, reference is now made to the accompanying drawings which illustrate a preferred embodiment of the invention. It is to be appreciated that this embodiment is given by way of illustration only and the invention is not to be limited by this illustration.

### BRIEF DESCRIPTION OF THE DRAWINGS

In the drawings:

FIG. 1 shows an installed automatic garage door opener fitted to a conventional roller door;

FIG. 2 shows a control panel of an electronic controller in accordance with a preferred embodiment of the invention; and

FIG. 3 shows a remote transmitter suitable for use in the system of the present invention.

### DESCRIPTION OF PREFERRED EMBODIMENT

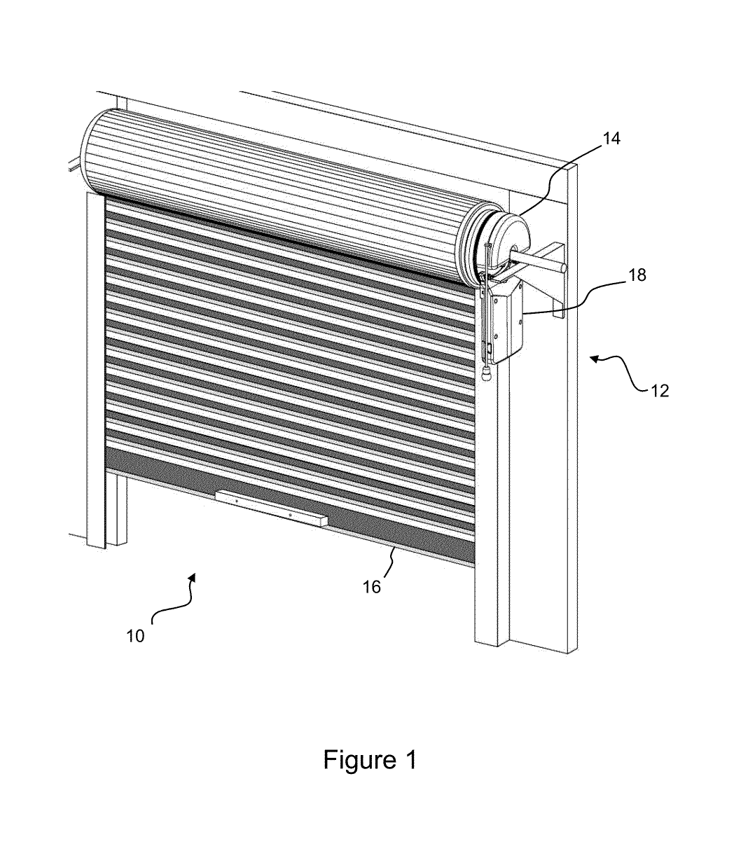

As mentioned previously, FIG. 1 shows a conventional roller door 10 as might be used on a garage, factory or other industrial premises. The roller door 10 includes a door curtain 16 which is movable between an upper, open position and a lower, closed position. A door opener 12, including a drive unit 14 and an electronic controller 18, drives the door curtain 16 between the open and closed positions. Externally, the door opener 12 looks the same whether or not it includes the method for setting travel limit positions in accordance with the present invention.

Although any known position encoder could be used to produce data representative of the door's position, the inventor has found that the angular position encoder described in Australian Innovation Patent No. 2007101214 is particular suitable. The entire contents of that patent publication are incorporated into this specification by cross reference.

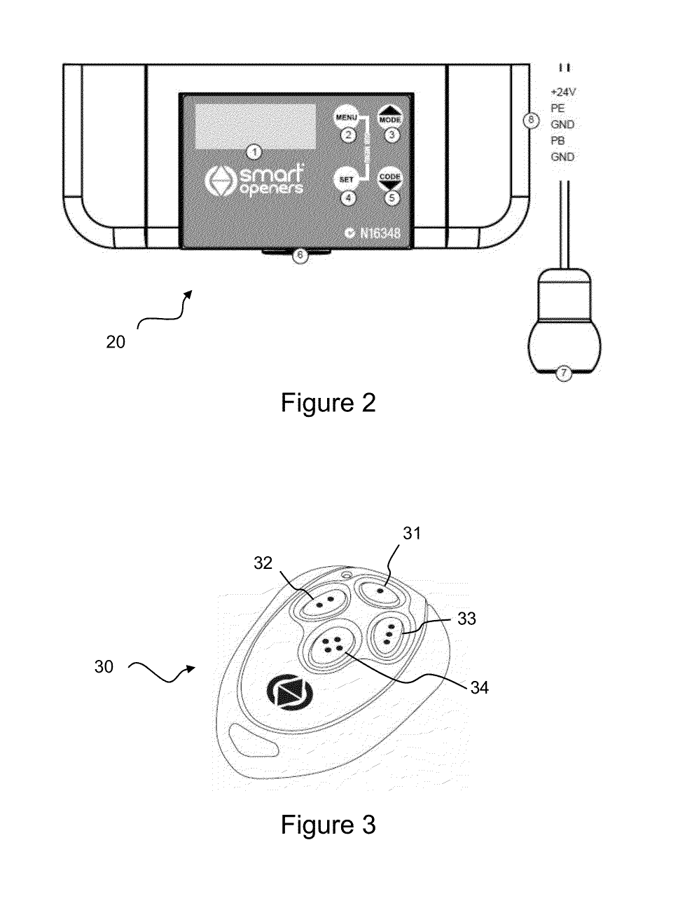

FIG. 2 shows a control panel 20 of the electronic controller 18 with its cover removed. The control panel 20 includes a visual display and control push buttons to facilitate installation and set up of the roller door 10 and door opener 12. The following operator controls are provided:
1. LCD Display—displays operating parameters and functions.
2. MENU Button—used to access set up menu and to change parameter settings.
3. MODE Button—used to save settings and exit to normal operation.
4. SET Button—used to save settings changes and move to next parameter.
5. CODE Button—used to store transmitter code.
6. PB (Push Button)—used to operate the door. (open/stop/close)
7. Manual Release Cord—used to engage/disengage the door for automatic/manual operation.
8. Input Terminal Block—used for connecting photo electric safety beam or external push button trigger.

The electronic controller 18 also includes a receiver (not shown) for receiving command signals from a remote control transmitter.

FIG. 3 shows a remote control transmitter 30 as may be used in the present invention. The transmitter 30 includes command push buttons 31 to 34 for issuing command signals to the electronic controller 18. Although the transmitter 30 shown in FIG. 3 includes four push buttons, only two are actually required for the purposes of the travel limit setting procedure of the present invention. The additional push buttons could be used for other purposes or for controlling other devices.

Installation and set up of the door opener 12 will now be described. Firstly, the roller door 10 is installed in a conventional manner together with the door opener 12. The operator controls provided on the control panel 20 within the electronic controller 18 may be used to set up all of the parameters of the controller 18 but the present invention is more concerned with the use of the remote transmitter 30 to programme at least the open and closed travel limit positions for the door curtain 16.

Once electrical power is connected to the electronic controller 18, it enters a SETTING mode. At that point the controller first performs a firmware check and then displays a welcome message on the screen 1 of the control panel 20. The installer then presses the CODE button 5 on the control panel followed by one of the command push buttons 31 to 34 on the transmitter 30. This procedure stores the code of the transmitter 30 in the controller 18.

The controller 18 is then ready to set the travel limit positions which, in accordance with the invention, can be achieved using the transmitter 30. In this way, the installer is able to visually monitor the precise position of the door curtain 16 as it is moved to its limit positions.

In one embodiment of the invention, the controller 18 automatically proceeds to the limit setting phase as soon as the code of the transmitter 30 has been stored. Alternatively, however, the method may require the installer to press the SET button 4 on the control panel 20 in order for the controller 18 to enter the limit setting phase.

The installer then presses a first command push button 31 on the transmitter 30 to move the door to a desired open position. The door curtain 16 moves upward, initially slowly and then with increasing speed, until the installer releases the button 31. If the installer overshoots the desired position he can then press a second command push button, for example, push button 34, to drive the door back down. Once again, the door initially travels slowly and then increases in speed. Alternatively, if the door curtain did not quite reach the desired limit position, he can then press the first push button 31 again in order to move the door curtain slightly higher. Again, the door initially travels slowly and then increases in speed.

During the secondary, or additional, fine movements of the door curtain, it's travel speed may be fixed or variable. In any event, it is advantageous for the speed to be slow at the beginning of the movement, and preferably significantly reduced relative to the normal speed prior to the first release of the push button 31. In this way, accurate movement of the door to the desired limit position is made easier.

At that point, according to the method of the invention, the installer must pause for a predetermined period, such as 5 seconds, until the controller 18 produces a beep and/or flashes a light to indicate that the position is set. Data representative of the final position of the door, from the angular position encoder, is then stored in the controller, thereby defining the open travel limit position.

The installer then drives the door curtain 16 downward towards the desired closed limit position by pressing and holding the second command push button 34 on the remote transmitter 30. Once again, if the installer overshoots the desired position he can raise the door slightly by pressing the first command push button 31. Alternatively, if necessary, he can lower it a bit further by pressing the second command push button again. As with the setting of the open limit position, the door speed is initially slow and then increases over time.

Once the installer is happy with the position of the door he must pause for another predetermined period, for example, 5 seconds, until the controller again causes a beep to be generated and/or a light to flash, thus indicating that the close limit position has been set. Data from the angular encoder representative of that position is then stored in the controller to thereby define the closed travel limit position.

The door opener then automatically switches from the SETTING mode to an OPERATE mode. In that mode, the door is movable between the open and closed travel limit positions by a user pressing the command push buttons 31 and 34 on the remote transmitter 30.

As will be appreciated, the method of the invention enables an installer to quickly and easily set the travel limit positions for a movable closure such as a garage roller door. Only two push buttons on the transmitter are required, to move the door up or down. Additional push buttons are not necessary and simultaneous depression of multiple push buttons also is unnecessary. The method is thus far more user friendly than prior art methods and is less prone to error or frustration. This makes the method far quicker for most installers.

Although a preferred embodiment of the invention is described here in detail, it will be appreciated by those skilled in the art that variations may be made thereto without departing from the spirit of the invention or the scope of the appended claims.

It should also be appreciated that the features disclosed herein may be combined with any one or more features disclosed in any one of the applicant's prior patents and/or patent applications. Details of these patents and patent applications may be obtained by conducting a search of the IP Australia database records.

1. A method for setting travel limit positions of a movable closure, the closure being movable between open and closed positions by a drive unit and associated electronic controller in response to command signals received from a remote transmitter, the method, during an installation phase, including the steps of:
moving the closure in a first travel direction towards a desired first limit position in response to a user pressing and holding a first command push button on the remote transmitter;
stopping movement of the closure when the user releases the first command push button; and
if no command push button is pressed for a first predetermined time period, storing data representative of the closure's stopped position, this data thereby defining the first travel limit position.

2. The method of claim 1, further including the steps of:
moving the closure in a second, opposite, travel direction towards a desired second limit position in response to a user pressing and holding a second command push button on the remote transmitter;
stopping movement of the closure when the user releases the second command push button; and
if no command push button is pressed for a second predetermined time period, storing data representative of the closure's stopped position, this data thereby defining the second travel limit position.

3. The method of claim 2, further including the steps of:
if the first command push button is pressed again within the first predetermined time period after being released, moving the closure in the first direction and stopping such movement when the first command push button is released; and
if the second command push button is pressed within the first predetermined time period after the first command push button is released, moving the closure in the second direction and stopping such movement when the second command push button is released;

4. The method of claim 3, further including the steps of:
if the second command push button is pressed again within the second predetermined time period after being released, moving the closure in the second direction and stopping such movement when the second command push button is released; and
if the first command push button is pressed within the second predetermined time period after the second command push button is released, moving the closure in the first direction and stopping such movement when the first command push button is released.

5. The method of claim 4, wherein secondary movements of the closure, being those movements which occur after the closure is stopped the first time, proceed at least initially at a slower speed than the earlier movement of the closure prior to first being stopped.

6. The method of claim 2, wherein the first limit position is an open limit position for the closure and the second limit position is its closed limit position

7. The method of claim 2, wherein the first predetermined time period is substantially equal to the second predetermined time period.

8. The method of claim 7, wherein the predetermined time periods are about five seconds each.

9. The method of claim 2, further including the step of:
providing a visible and/or audible signal to the user when each of the predetermined time periods has elapsed and the associated travel limit position has been defined.

10. The method of claim 2, including operating the closure in a SETTING mode during the installation phase to define the first and second travel limit positions using the remote transmitter, and automatically switching to an OPERATE mode after the second limit position has been defined, the closure then being movable between the first and second travel limit positions.

11. A control system for controlling the operation of a movable closure, the closure being movable between an open limit position and a closed limit position, the system including:
a drive unit including an electric motor for driving the closure between the open and closed limit positions;
an electronic controller for controlling the drive unit and including a receiver for receiving command signals; and
a remote transmitter having a plurality of command push buttons for issuing the command signals to the electronic controller, wherein, during an installation phase, the electronic controller is configured to:
move the closure in a first travel direction towards a desired first limit position in response to a user pressing and holding a first command push button on the remote transmitter;
stop movement of the closure when the user releases the first command push button; and
if no command push button is pressed for a first predetermined time period, store data representative of the closure's stopped position, this data thereby defining the first travel limit position.

12. The control system of claim 11, wherein the electronic controller is further configured to:
move the closure in a second, opposite, travel direction towards a desired second limit position in response to a user pressing and holding a second command push button on the remote transmitter;
stop movement of the closure when the user releases the second command push button; and
if no command push button is pressed for a second predetermined time period, store data representative of the closure's stopped position, this data thereby defining the second travel limit position.

13. The control system of claim 12, wherein the electronic controller is further configured such that:
if the first command push button is pressed again within the first predetermined time period after being released, the closure is moved in the first direction and such movement is stopped when the first command push button is released; and
if the second command push button is pressed within the first predetermined time period after the first command push button is released, the closure is moved in the second direction and such movement is stopped when the second command push button is released.

14. The control system of claim 13, wherein the electronic controller is further configured such that:
if the second command push button is pressed again within the second predetermined time period after being released, the closure is moved in the second direction and such movement is stopped when the second command push button is released; and
if the first command push button is pressed within the second predetermined time period after the second command push button is released, the closure is moved in the first direction and such movement is stopped when the first command push button is released.

15. The control system of claim 14, wherein secondary movements of the closure, being those movements which occur after the closure is stopped the first time, proceed at least initially at a slower speed than the earlier movement of the closure prior to first being stopped.

16. The control system of claim 12, wherein the first limit position is an open limit position for the closure and the second limit position is its closed limit position

17. The control system of claim 12, wherein the first predetermined time period is substantially equal to the second predetermined time period.

18. The control system of claim 17, wherein the predetermined time periods are about five seconds each.

19. The control system of claim 12, wherein the electronic controller is further configured to provide a visible and/or audible signal to the user when each of the predetermined time periods has elapsed and the associated travel limit position has been defined.
